(19) United States
(12) Patent Application Publication
(10) Pub. No.: US 2011/0222883 A1
(43) Pub. Date: Sep. 15, 2011

(54) IMAGE FORMING APPARATUS

(75) Inventors: Takatoshi Hamada, Toyokawa-shi (JP); Yoshikazu Watanabe, Toyohashi-shi (JP)

(73) Assignee: Konica Minolta Business Technologies, Inc., Chiyoda-ku (JP)

(21) Appl. No.: 13/044,589

(22) Filed: Mar. 10, 2011

(30) Foreign Application Priority Data
Mar. 11, 2010 (JP) 2010-054138

(51) Int. Cl. G03G 15/043

(52) U.S. Cl. 399/51; 399/177

(57) ABSTRACT

An image forming apparatus having a first photosensitive member and a second photosensitive member that are arranged side by side along a moving direction of a transfer member, the first photosensitive drum being disposed at an upstream position with respect to the moving direction of the transfer member and the second photosensitive member being disposed at a downstream position; a light source for emitting a beam; and an optical system for directing the beam emitted from the light source to the first and the second photosensitive drums. The optical system comprises a switching optical element that is capable of turning into a first state to direct the beam emitted from the light source to the first photosensitive drum and into a second state to direct the beam to the second photosensitive drum, and a condition, A+B1−B2>F+E×D is satisfied.

This application is based on Japanese Patent Application No. 2010-054138 filed on Mar. 11, 2010, of which content is incorporated herein by reference.

### BACKGROUND OF THE INVENTION

### Field of the Invention

The present invention relates to an image forming apparatus, and more particularly to an electrophotographic copying machine or printer.

In recent years, in the field of copying machines and printers, apparatuses that are capable of forming color images predominate, and a tandem method is generally adopted. In forming a color copy of an original image by the tandem method, the original image is resolved into four colors, namely, Y (yellow), M (magenta), C (cyan) and K (black), and images of four colors are formed on four photosensitive members arranged side by side in accordance with the respective color data.

With respect to a laser scanning optical apparatus employed in such a tandem type image forming apparatus, it is well known that in exposing a plurality of photosensitive members, optical paths of beams emitted from light sources are switched by a deflector time-divisionally. Japanese Patent Laid-Open Publication No. 2005-10268 and Japanese Patent Laid-Open Publication No. 2005-17607 teach that the exposure values of the respective photosensitive members are set individually and that a two-dimensional scanning mirror is used as the deflector. Japanese Patent Laid-Open Publication No. 2002-214553 teaches that by using an optical axis separating element, beams emitted from a plurality of light sources are separated to every beam from each of the light sources by reflection/transmission.

In these conventional laser scanning optical apparatuses, it is necessary to provide the same number of light sources as the number of photosensitive members, that is, if four photosensitive members are provided for formation of images of four colors, four light sources are necessary. From the viewpoint of the reduction in cost, it is desired that the number of light sources is reduced.

### SUMMARY OF THE INVENTION

An object of the present invention is to provide an image forming apparatus that forms images on a plurality of photosensitive members by use of a less number of light sources.

Another object of the present invention is to provide an image forming apparatus wherein synchronizing signals used to determine the timings of starting image writing on a plurality of photosensitive members are certainly generated even when a beam is switched among optical paths to the respective photosensitive members.

An image forming apparatus according to a first aspect of the present invention comprises: a first photosensitive member and a second photosensitive member that are arranged side by side at a specified interval along a moving direction of a transfer member onto which toner images formed on the first and the second photosensitive drums are transferred, the first photosensitive drum being disposed at an upstream position with respect to the moving direction of the transfer member and the second photosensitive member being disposed at a downstream position with respect to the moving direction of the transfer member; a light source for emitting a beam; and an optical system for directing the beam emitted from the light source to the first and the second photosensitive drums; wherein the optical system comprises a switching optical element that is capable of turning into a first state to direct the beam emitted from the light source to the first photosensitive drum and into a second state to direct the beam to the second photosensitive drum; and wherein a condition, A+B1−B2>F+E×D is satisfied, where A is a distance between a transfer point of the first photosensitive drum and a transfer point of the second photosensitive drum, B1 is a distance between an exposure point of the first photosensitive drum and the transfer point of the first photosensitive drum, B2 is a distance between an exposure point of the second photosensitive drum and the transfer point of the second photosensitive drum, D is a circumferential speed of rotation of the first and the second photosensitive drums, E is a time that is necessary for the switching optical element to turn from the first state to the second state or to turn from the second state to the first state; and F is a length of a copy sheet in a sub-scanning direction.

An image forming apparatus according to a second aspect of the present invention comprises: a first photosensitive member and a second photosensitive member that are arranged side by side at a specified interval along a moving direction of a transfer member onto which toner images formed on the first and the second photosensitive drums are transferred, the first photosensitive drum being disposed at an upstream position with respect to the moving direction of the transfer member and the second photosensitive member being disposed at a downstream position with respect to the moving direction of the transfer member; a light source for emitting a beam; an optical system for directing the beam emitted from the light source to the first and the second photosensitive drums; and a beam detector for generating synchronizing signals used to determine timings of starting image writing on the first and the second photosensitive drums; wherein the optical system comprises a switching optical element that turns between a first state to direct the beam emitted from the light source to the first photosensitive drum and a second state to direct the beam to the second photosensitive drum; and wherein a beam splitting optical element for directing a part of the beam emitted from the light source to the beam detector is disposed before the switching optical element.

An image forming apparatus according to a third aspect of the present invention comprises: a first photosensitive member, a second photosensitive member, a third photosensitive member and a fourth photosensitive member that are arranged side by side at regular intervals along a moving direction of a transfer member onto which toner images formed on the first, the second, the third and the fourth photosensitive drums are transferred, the first photosensitive drum being disposed at a most upstream position with respect to the moving direction of the transfer member and the fourth photosensitive member being disposed at a most downstream position with respect to the moving direction of the transfer member; light sources for emitting beams for exposure of the first, the second, the third and the fourth photosensitive drums; and an optical system for directing the beams emitted from the light sources to the first, the second, the third and the fourth photosensitive drums; wherein the optical system comprises a switching optical element that is capable of turning into a first state to direct one of the beams emitted from one of the light sources to the first photosensitive drum and into a second state to direct the beam from the light source to the fourth photosensitive drum; and wherein a condition, A+B1−B2>F+E×D is satisfied, where A is a distance between a transfer point of the first photosensitive drum and a transfer point of the fourth photosensitive drum, B1 is a distance between an exposure point of the first photosensitive drum and the transfer point of the first photosensitive drum, B2 is a distance between an exposure point of the fourth photosensitive drum and the transfer point of the fourth photosensitive drum, D is a circumferential speed of rotation of the first and the fourth photosensitive drums, E is a time that is necessary for the switching optical element to turn from the first state to the second state or to turn from the second state to the first state; and F is a length of a copy sheet in a sub-scanning direction.

An image forming apparatus according to a fourth aspect of the present invention comprises: a first photosensitive drum, a second photosensitive drum, a third photosensitive drum and a fourth photosensitive drum that are arranged side by side in this order at regular intervals along a moving direction of a transfer member onto which toner images formed on the first, the second, the third and the fourth photosensitive drums are transferred, the first, the second, the third and the fourth photosensitive drums having equal diameters; a first light source for emitting a beam; a first switching optical element that is capable of turning into a first state to direct the beam emitted from the first light source to the first photosensitive drum and into a second state to direct the beam emitted from the first light source to the third photosensitive drum; a second light source for emitting a beam; and a second switching optical element that is capable of turning into a first state to direct the beam emitted from the second light source to the second photosensitive drum and into a second state to direct the beam emitted from the second light source to the fourth photosensitive drum; wherein a condition, A>F+E×D is satisfied, where A is a distance between a transfer point of the first photosensitive drum and a transfer point of the third photosensitive drum, D is a circumferential speed of rotation of the first, the second, the third and the fourth photosensitive drums, E is a time that is necessary for each of the first and the second switching optical elements to turn from the first state to the second state or to turn from the second state to the first state; and F is a length of a copy sheet in a sub-scanning direction.

### BRIEF DESCRIPTION OF THE DRAWINGS

These and other objects and features of the present invention will be apparent from the description with reference to the accompanying drawings, in which:

FIG. 1 is a skeleton framework of an image forming apparatus according to an embodiment of the present invention;

FIG. 2 is a plan view of a laser scanning optical unit employed in the image forming apparatus;

FIG. 3 is an illustration showing optical paths in the laser scanning optical unit with respect to a sub-scanning direction;

FIG. 4 is a block diagram of a control section for the laser scanning optical unit;

FIG. 5 is a time chart showing an exemplary control of the laser scanning optical unit;

FIG. 6 is a flowchart showing a main routine of the control section; and

FIG. 7 is a flowchart showing a subroutine of the control section for performing a printing process.

### DETAILED DESCRIPTION OF THE PREFERRED EMBODIMENTS

An image forming apparatus according to an embodiment of the present invention will be hereafter described with reference to the accompanying drawings.

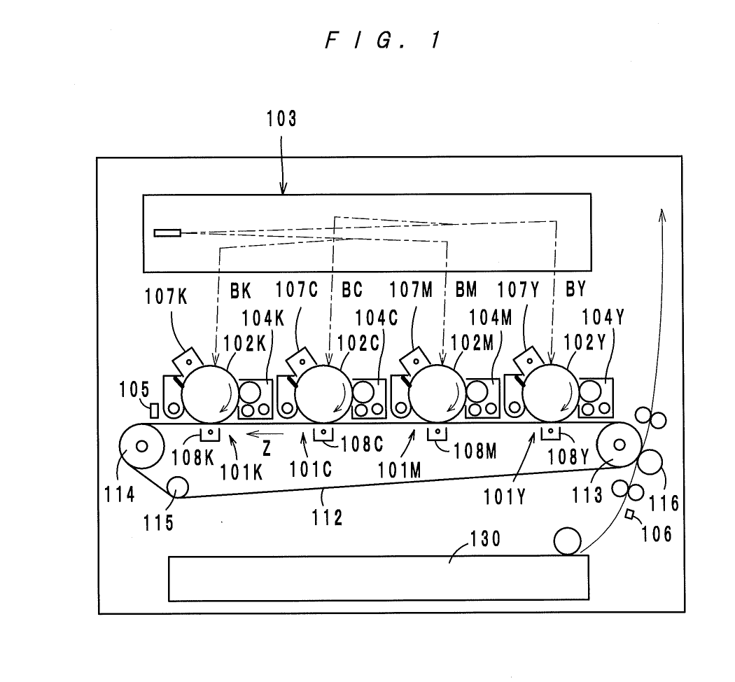

### General Structure of the Image Forming Apparatus; See FIG. 1

An image forming apparatus shown by FIG. 1 is an electrophotographic color printer wherein images of four colors (Y: yellow, M: magenta, C: cyan and K: black) are formed in the tandem method. Images of the four colors are formed at the respective image forming stations 101 and are combined together on an intermediate transfer belt 112. In the drawings, the alphabets “Y”, “M”, “C” and “K” attached to the reference numbers mean that the components are for formation of a yellow image, for formation of a magenta image, for formation of a cyan image and for formation of a black image, respectively.

Each of the image forming stations 101 (101Y, 101M, 101C, 101K) generally comprises a photosensitive drum 102 (102Y, 102M 102C, 102K), a laser scanning optical unit 103, a charger 107 (107Y, 107M, 107C, 107K), a developing device 104 (104Y, 104M, 104C, 104K), transfer chargers 108 (108Y, 108M, 108C, 108K), etc. The laser scanning optical unit 103 is disposed above the image forming stations 101.

Beams BY, BM, BC and BK are emitted from the laser scanning optical unit 103 to the respective photosensitive drums 102, and thereby, images of the respective colors are formed. Immediately under the image forming stations 101, an intermediate transfer belt 112 is stretched endlessly among rollers 113, 114 and 115, and is driven to rotate in a direction shown by arrow “Z”. A second transfer roller 116 is disposed at a position (second transfer position) opposite to the roller 113 with the transfer belt 112 in-between. In a lower part of the image forming apparatus, an automatic sheet feeder 130 for feeding copy sheets one by one is disposed.

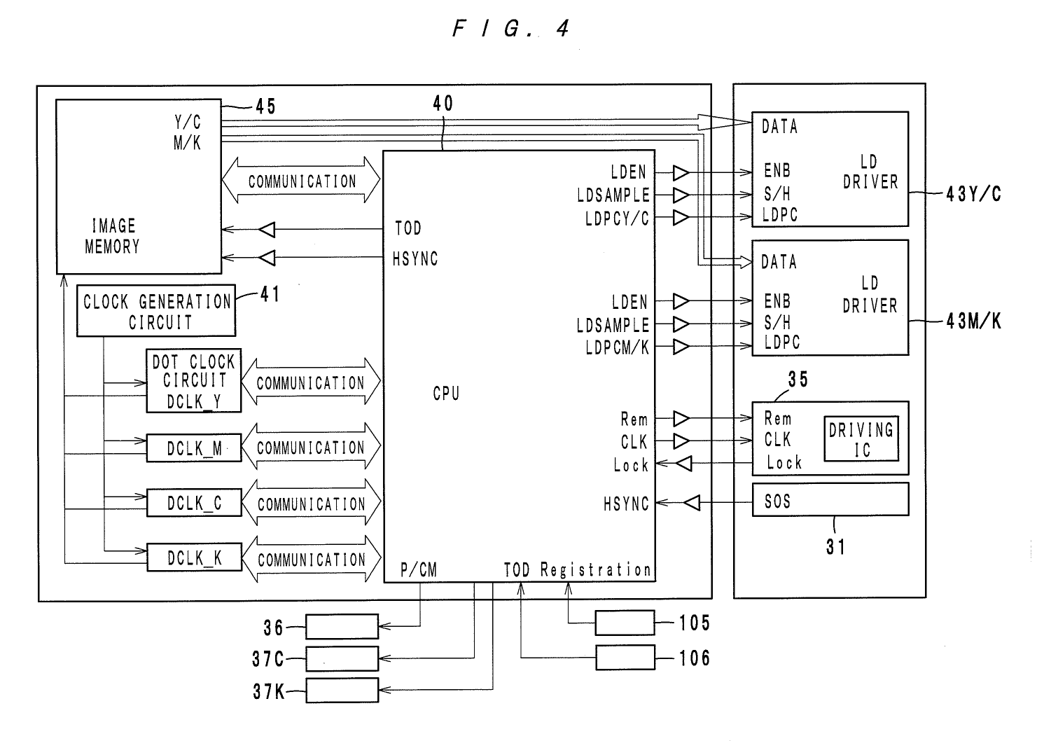

Image data for the respective colors, Y, M, C and K are sent from an image reader (scanner) or a computer (not shown) to an image memory 45 (see FIG. 4), and the laser scanning optical unit 103 is driven in accordance with these image data, and accordingly, toner images of the respective colors are formed on the respective photosensitive drums 102. This electrophorographic process is well known, and a detailed description thereof is omitted.

The toner images formed on the photosensitive drums 102 are transferred onto the intermediate transfer belt 112 while the intermediate transfer belt 112 is rotating in the direction “Z”, and thereby, the images of the four colors are combined into a composite image (first transfer). Meanwhile, a copy sheet is fed upward from the sheet feeder 130, and at the second transfer position, the composite image is transferred onto the copy sheet by an electric field applied from the transfer roller 116 (second transfer). Thereafter, the copy sheet is fed to a fixing device (not shown), where toner is fixed on the copy sheet, and is ejected onto an upper surface of the image forming apparatus.

A TOD sensor 106 for detecting a copy sheet is disposed immediately before the second transfer position so that the copy sheet and the image on the intermediate transfer belt 112 can be synchronized with each other. A registration sensor 105 for detecting a registration test image formed on the intermediate transfer belt 112 is provided. The photosensitive stations 101 form registration test images on the intermediate transfer belt 112, and the registration test images are detected by the registration sensor 105. Based on the results of this detection, the emission timings of the beams BY, BM, BC and BK are adjusted so that the images of the colors Y, M, C and K can be superimposed on the belt 112 accurately.

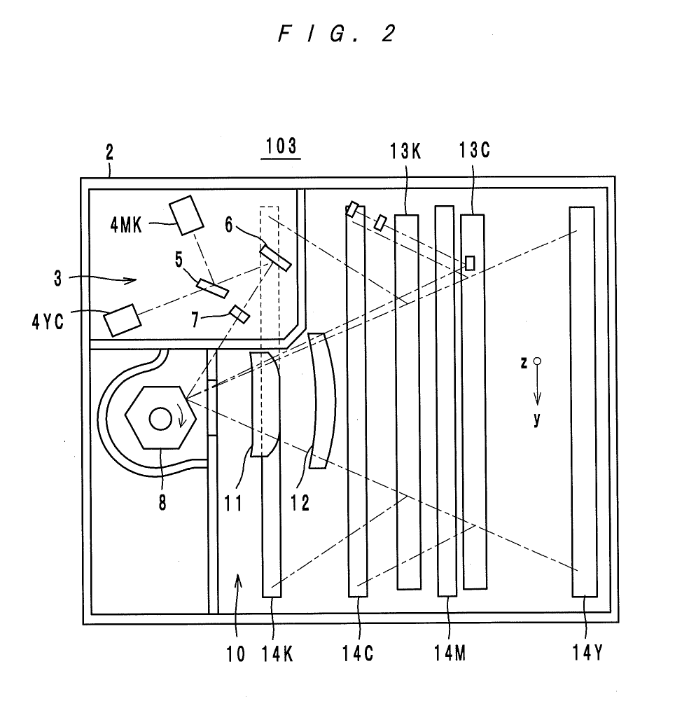

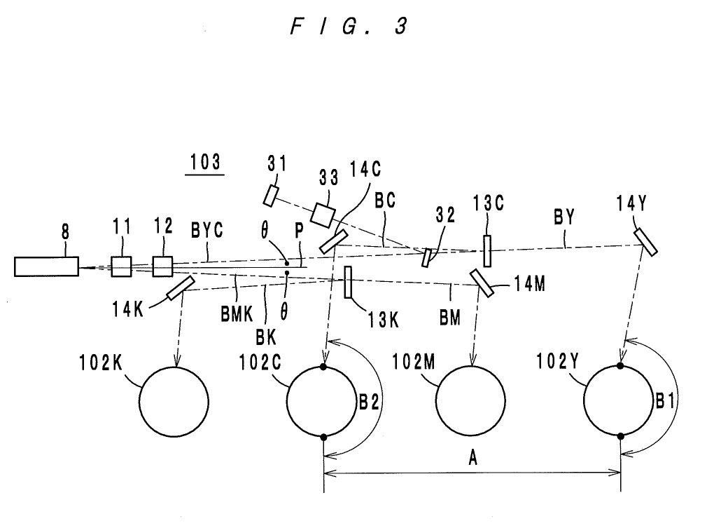

### Laser Scanning Optical Unit; See FIGS. 2 and 3

As shown by FIG. 2, the laser scanning optical unit 103 generally comprises a light source section 3, a polygon mirror 8 and a scanning optical system 10, and these parts are encased in a housing 2. The light source section 3 comprises a laser diode 4YC for emitting a beam BYC for formation of images of Y (yellow) and C (cyan), a laser diode 4MK for emitting a beam BMK for formation of images of magenta (M) and black (K), plane mirrors 5 and 6, and a cylindrical lens 7. The scanning optical system 10 comprises scanning lenses 11 and 12, optical path switching mirrors 13C and 13K, and plane mirrors 14Y, 14M, 14C and 14K. The optical path switching mirrors 13C and 13K are moved by stepping motors alternatively to their respective intruding positions to reflect the beams BYC and BMK or their respective retreating positions to transmit the beams BYC and BMK.

The beams BYC and BMK emitted from the laser diodes 4YC and 4MK are collimated into parallel lights by a collimator lens (not shown) and are reflected by the mirrors 5 and 6 to enter the cylindrical lens 7. By the cylindrical lens 7, the beams BYC and BMK are converged with respect to a sub-scanning direction “z” and are directed to the polygon mirror 8. These beams BYC and BMK are deflected in a main-scanning direction “y” at an equiangular velocity by rotation of the polygon mirror 8. Thereafter, the beams BYC and BMK pass through the scanning lenses 11 and 12. Thereby, the beams BYC and BMK obtain f0 characteristics, and necessary aberration corrections are made.

As shown in FIG. 3, the beams BYC and BMK are reflected by the polygon mirror 8 upward and downward, respectively, at an angle θ to the optical axis P. When the optical path switching mirror 13C is in the retreating position, the beam BYC travels forward and is reflected by the mirror 14Y to be directed to the photosensitive drum 102Y. In this state, the beam BYC serves as a beam BY and scans the surface of the photosensitive drum 102Y in the main-scanning direction “y” to form an electrostatic latent image on the photosensitive drum 102Y. When the optical path switching mirror 13K is in the retreating position, the beam BMK travels forward and is reflected by the mirror 14M to be directed to the photosensitive drum 102M. In this state, the beam BMK serves as a beam BM and scans the surface of the photosensitive drum 102M in the main-scanning direction “y” to form an electrostatic latent image on the photosensitive drum 102M. When the optical path switching mirror 13C is in the intruding position to intrude in the optical path, the beam BYC is reflected by the mirror 13C and further reflected by the mirror 14C to be directed to the photosensitive drum 102C. In this state, the beam BYC serves as a beam BC and scans the surface of the photosensitive drum 102C in the main-scanning direction “y” to form an electrostatic latent image on the photosensitive drum 102C. When the optical path switching mirror 13K is in the intruding position to intrude in the optical path, the beam BMK is reflected by the mirror 13K and further reflected by the mirror 14K to be directed to the photosensitive drum 102K. In this state, the beam BMK serves as a beam BK and scans the surface of the photosensitive drum 102K in the main-scanning direction “y” to form an electrostatic latent image on the photosensitive drum 102K.

The scanning optical system 10 is further provided with an SOS sensor (photodiode) 31 for generating horizontal synchronizing signals used to determine the timings of starting image writing on the respective photosensitive drums 102. Before modulating laser emission in accordance with image data, the laser diode 4YC emits a beam forcibly, and this forcibly emitted beam is directed to the SOS sensor 31. For this purpose, a plane mirror 32 is disposed immediately before the optical path switching mirror 13C to split the beam BYC, and a beam BH split from the beam BYC enters the SOS sensor 31 through a convergent lens 33. A control procedure for generating horizontal synchronizing signals based on light reception at the SOS sensor 31 is well known, and a detailed description thereof is omitted.

### Control Section; See FIG. 4

Next, referring to FIG. 4, a control section for the laser scanning optical unit 103 is described. This control section generally comprises a CPU (microcomputer) 40, a driving clock generation circuit 41 and an image memory 45. The CPU 40 controls a motor 35 for driving the polygon mirror 8. A beam incident to the SOS sensor 31 is subjected to photoelectric conversion, and a signal resulting from the conversion is inputted into the CPU 40. The CPU 40 digitalizes the signal to generate horizontal synchronizing signals HSYNC.

Into the CPU 40, further, a copy sheet detection signal and a registration test image detection signal are inputted from the TOD sensor 106 and from the registration sensor 105, respectively. Based on the signal sent from the registration sensor 105, the CPU 40 calculates correction values for registration, such as correction values for the positions with respect to the main-scanning direction and with respect to the sub-scanning direction and the magnification ratio with respect to the main-scanning direction of each color, etc. Also, the CPU 40 controls the forced laser emission for generation of horizontal synchronizing signals and the laser emission for formation of a registration test image.

The CPU 40 outputs horizontal synchronizing signals HSYNC and an image request signal TOD to the image memory 45. The image memory 45 includes a plurality of sub-scanning counters for counting the horizontal synchronizing signals. The signal TOD triggers the counting by the sub-scanning counters for registration with respect to the sub-scanning direction. Further, registration with respect to the main-scanning direction is carried out, and image data for Y/C and image data for M/K are sent to LD drivers 43Y/C and 43M/K, respectively. This data sending is carried out at a time determined by taking into account the registration correction values calculated by the CPU 40.

The image data DATA sent to the LD drivers 43Y/C and 43M/K are adjusted according to the positions of the beams emitted from the laser diode 4YC and 4MK relative to the positions of the respective photosensitive drums 102 so that images can be formed on the photosensitive drums 102 in accurate positions with respect to the main-scanning direction. Also, the CPU 40 outputs an intrusion/retreatment signal to driving motors 37C and 37K for the optical path switching mirrors 13C and 13K. Further, the CPU 40 controls various other devices and instruments in the image forming apparatus. For example, the CPU 40 outputs rotation control signals P/CM to driving motors 36 for the photosensitive drums 102 and outputs a light quantity control signal to the LD drivers 43Y/C and 43M/K.

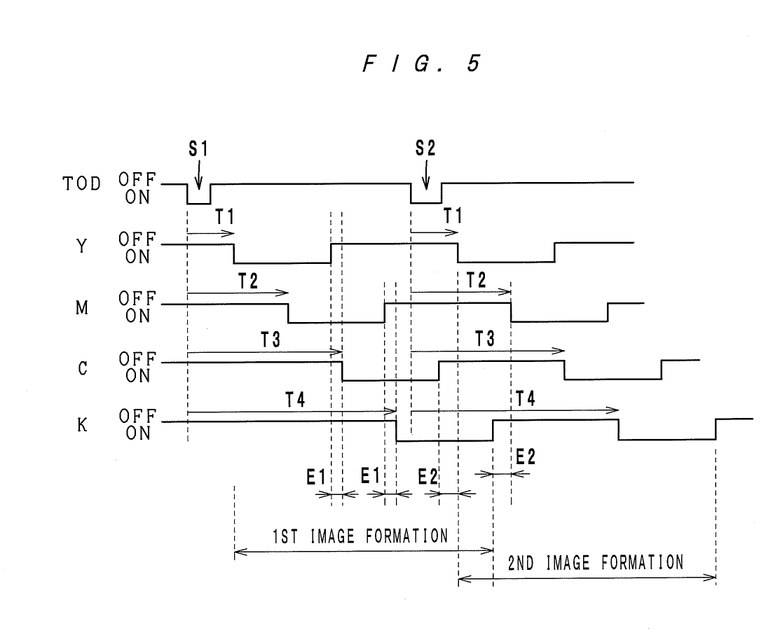

### Image Formation Control; See FIG. 5

Now referring to FIG. 5, image formation control in the image forming apparatus according to this embodiment is described. In FIG. 5, “ON” shows an active state, and “OFF” shows an inactive state. In this embodiment, image forming processes proceed in the order of yellow, magenta, cyan and black. One light source (laser diode 4YC) is used for exposure to form images of yellow and cyan, and another light source (laser diode 4MK) is used for exposure to form images of magenta and black. Therefore, the light sources are controlled such that the time of laser emission for Y image formation and the time of laser emission for C image formation will not overlap and such that the time of laser emission for M image formation and the time of laser emission for K image formation will not overlap.

First, the TOD sensor 106 detects the leading edge of a first copy sheet S1, and when times T1, T2, T3 and T4 has passed since then, the respective sub-scanning counters start counting the horizontal synchronizing signals HSYNC. Thereby, the times to output image data of the respective colors are determined. The optical path switching mirrors 13C and 13K are initially set in their retreating (transmitting) positions. In this state, the beams BY and BM scan on the photosensitive drums 102Y and 102M, respectively, to write images thereon. After the image writing on the photosensitive drum 102Y is completed, the switching mirror 13C is moved to intrude into the optical path. In this state, the beam BC scans on the photosensitive drum 102C to write an image thereon. Also, after the image writing on the photosensitive drum 102M is completed, the switching mirror 13K is moved to intrude into the optical path. In this state, the beam BK scans on the photosensitive drum 102K to write an image thereon. In this way, first images of the respective colors are formed and combined into a first composite image on the intermediate transfer belt 112, and the composite image is transferred onto the copy sheet S1.

In printing a second image on a second copy sheet S2, when the TOD sensor 106 detects the leading edge of the second copy sheet S2, first, the switching mirror 13C is moved to its retreating position. Also, the switching mirror 13K is moved to its retreating position when the writing of the first image on the photosensitive drum 102K is completed. Thereafter, the switching mirrors 13C and 13K are controlled to move in the same way as described above, and second images of the respective colors are formed on the photosensitive drums 102.

In order to carry out the image formation control above, it is necessary that the length of a copy sheet in the sub-scanning direction is shorter than the distance between the photosensitive drums 102 exposed to one light source. More specifically, it is necessary to satisfy the condition A+B1−B2>F+E×D (see FIG. 3).

The parameters in the conditional expression are as follows. Although the following definitions of the parameters are in connection with the photosensitive drums 102Y and 102C, the parameters in connection with the photosensitive drums 102M and 102K shall be set in the same way.

A is the distance between a transfer point of the photosensitive drum 102Y and a transfer point of the photosensitive drum 102C;

B1 is the distance between an exposure point and the transfer point of the photosensitive drum 102Y;

B2 is the distance between an exposure point and the transfer point of the photosensitive drum 102C;

D is the circumferential speed of rotation of the photosensitive drums 102Y and 102C;

E is the time that is necessary to move the switching mirrors 13C from the retreating position to the intruding position or from the intruding position to the retreating position; and

F is the length of a copy sheet in the sub-scanning direction “z”.

By satisfying the conditional expression in arranging the photosensitive drums 102 side by side along the moving direction of the intermediate transfer belt 112, it becomes possible to expose two photosensitive drums 102 to a beam emitted from one light source (laser diode 4YC or 4MK) by switching the optical path. Accordingly, only a half number of light sources of the number of photosensitive drums 102 are necessary to form a color image.

In this embodiment, a time E1 that is necessary to move each of the switching mirrors 13C and 13K from the retreating position to the intruding position and a time E2 that is necessary to move each of the switching mirrors 13C and 13K from the intruding position to the retreating position is in the relationship of E1<E2, and in a process of forming one color image, the switching mirrors 13C and 13K are initially set to their retreating positions. Accordingly, it is possible to take sufficient time for the movements of the switching mirrors 13C and 13K from their respective intruding positions to their respective retreating positions, which need more time, while the trailing portion of the first sheet and the leading portion of the second sheet with an interval in-between are traveling.

In this embodiment, the plane mirror 32 for directing the beam to the SOS sensor 31 for generating horizontal synchronizing signals is disposed before the switching mirror 13C. Therefore, horizontal synchronizing signals can be certainly generated regardless of the position of the switching mirror 13C.

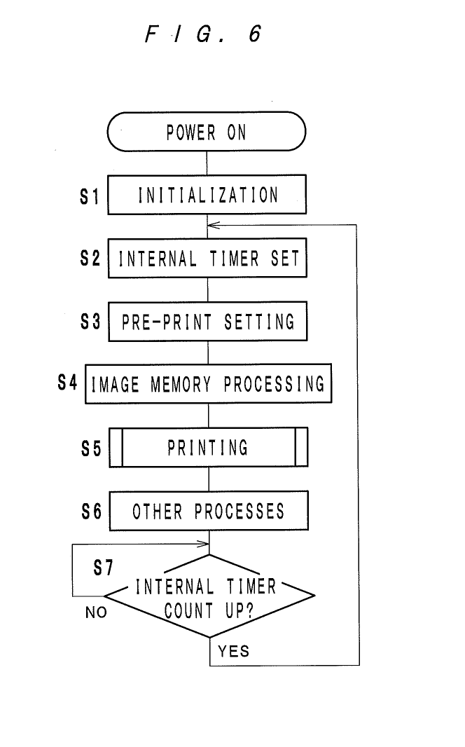

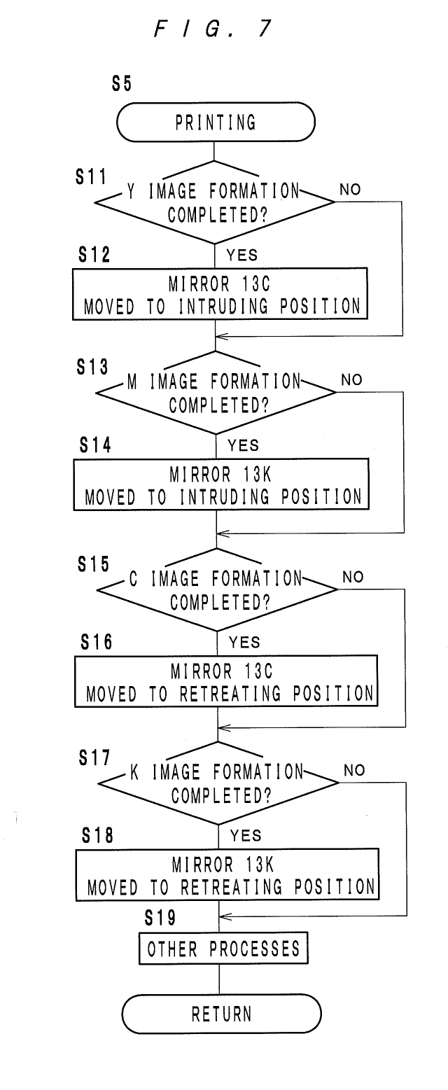

### Control Procedure; See FIGS. 6 and 7

Next, a control procedure of the CPU 40 is described. FIG. 6 shows a main routine of the CPU 40. When the power is turned on, first, a RAM, timers, etc. incorporated in the CPU 40 are initialized (step S1), and an internal timer is set (step S2). Thereafter, the CPU 40 sequentially carries out a pre-print setting process (step S3), an image memory process (step S4), a printing process (step S5) and other processes (step S6) such as temperature regulation and detection of a paper jam, etc., and on the count-up of the internal timer (YES at step S7), the routine returns to step S2.

FIG. 7 shows a subroutine of the printing process carried out at step S5. When completion of yellow (Y) image formation is confirmed (YES at step S11), the switching mirror 13C is moved to the intruding position (step S12). When completion of magenta (M) image formation is confirmed (YES at step S13), the switching mirror 13K is moved to the intruding position (step S14). Next, when completion of cyan (C) image formation is confirmed (YES at step S15), the switching mirror 13C is moved to the retreating position (step S16). When completion of black (K) image formation is confirmed (YES at step S17), the switching mirror 13K is moved to the retreating position (step S18). Other processes for printing are carried out at step S19.

### Modification

With the laser scanning optical unit 103 described above, the photosensitive drums 102Y and 102C, which are located first and third, respectively, in the rotating direction “Z” of the transfer belt 112, are irradiated with the beam BYC emitted from the laser diode 4YC, and the photosensitive drums 102M and 102K, which are located second and forth, respectively, in the rotating direction “Z” of the transfer belt 112, are irradiated with the beam BMK emitted from the laser diode 4MK. However, the laser scanning optical unit 103 may be modified such that the photosensitive drums 102Y and 102K, which are located first and fourth, respectively, in the rotating direction “Z” of the transfer belt 112, can be irradiated with a beam BYK emitted from a single laser diode. In this case, the laser scanning optical unit 103 comprises an optical switching mirror 13 for switching the optical path of the beam BYK to the photosensitive drum 102Y and to the photosensitive drum 102K. This optical switching mirror 13 is movable between a retreating position and an intruding position so as to switch the optical path of the beam BYK in the same way as described above in connection with the optical switching mirrors 13C and 13K.

In order to carry out image formation control of the image forming apparatus having the modified optical scanning unit 103, it is necessary to satisfy the condition A+B1−B2>F+E×D. In this case, the parameters in the conditional expression are as follows.

A is the distance between a transfer point of the photosensitive drum 102Y and a transfer point of the photosensitive drum 102K;

B1 is the distance between an exposure point and the transfer point of the photosensitive drum 102Y;

B2 is the distance between an exposure point and the transfer point of the photosensitive drum 102K;

D is the circumferential speed of rotation of the photosensitive drums 102Y and 102K;

E is the time that is necessary to move the switching mirror 13 from the retreating position to the intruding position or from the intruding position to the retreating position; and

F is the length of a copy sheet in the sub-scanning direction “z”.

### Other Embodiments

The light sources may be of a single-beam type having a single light emitting element or may be of a multi-beam type having a plurality of light emitting elements. The structure of the image forming stations and the structure of the control section may be arbitrarily designed. The intermediate transfer belt is not indispensable, and the image forming apparatus may be of a type transferring images from photosensitive drums to a copy sheet directly.

The optical path switching elements are not necessarily mirrors that can be moved to intrude into and retreat from the optical paths as used in the embodiment above. Instead of such mirrors, shutters that turn from a transmitting state to a reflecting state and from the reflecting state to the transmitting state or alternatively liquid crystal optical elements may be used.

In an image forming apparatus according to any of these embodiments, only a half number of light sources of the number of photosensitive drums are necessary, and accordingly, the cost can be reduced. Also, in order to direct a part of a beam to a sensor for generating horizontal synchronizing signals, the beam is split before an optical path switching element, and therefore, horizontal synchronizing signals can be certainly generated regardless of the state of the switching optical element.

Although the present invention has been described in connection with the preferred embodiments above, it is to be noted that various changes and modifications are possible to those who are skilled in the art. Such changes and modifications are to be understood as being within the scope of the present invention.

What is claimed is:

1. An image forming apparatus comprising:
a first photosensitive member and a second photosensitive member that are arranged side by side at a specified interval along a moving direction of a transfer member onto which toner images formed on the first and the second photosensitive drums are transferred, the first photosensitive drum being disposed at an upstream position with respect to the moving direction of the transfer member and the second photosensitive member being disposed at a downstream position with respect to the moving direction of the transfer member;
a light source for emitting a beam; and
an optical system for directing the beam emitted from the light source to the first and the second photosensitive drums;
wherein the optical system comprises a switching optical element that is capable of turning into a first state to direct the beam emitted from the light source to the first photosensitive drum and into a second state to direct the beam to the second photosensitive drum; and
wherein a condition, A+B1−B2>F+E×D is satisfied, where A is a distance between a transfer point of the first photosensitive drum and a transfer point of the second photosensitive drum, B1 is a distance between an exposure point of the first photosensitive drum and the transfer point of the first photosensitive drum, B2 is a distance between an exposure point of the second photosensitive drum and the transfer point of the second photosensitive drum, D is a circumferential speed of rotation of the first and the second photosensitive drums, E is a time that is necessary for the switching optical element to turn from the first state to the second state or to turn from the second state to the first state; and F is a length of a copy sheet in a sub-scanning direction.

2. An image forming apparatus according to claim 1, wherein when a time E1 that is necessary for the optical element to turn from the second state to the first state and a time E2 that is necessary for the optical element to turn from the first state to the second state are in a relationship of E1<E2, the optical element is, first, set to the second state for exposure of the second photosensitive drum.

3. An image forming apparatus comprising:
a first photosensitive member and a second photosensitive member that are arranged side by side at a specified interval along a moving direction of a transfer member onto which toner images formed on the first and the second photosensitive drums are transferred, the first photosensitive drum being disposed at an upstream position with respect to the moving direction of the transfer member and the second photosensitive member being disposed at a downstream position with respect to the moving direction of the transfer member;
a light source for emitting a beam;
an optical system for directing the beam emitted from the light source to the first and the second photosensitive drums; and
a beam detector for generating synchronizing signals used to determine timings of starting image writing on the first and the second photosensitive drums;
wherein the optical system comprises a switching optical element that turns between a first state to direct the beam emitted from the light source to the first photosensitive drum and a second state to direct the beam to the second photosensitive drum; and
wherein a beam splitting optical element for directing a part of the beam emitted from the light source to the beam detector is disposed before the switching optical element.

4. An image forming apparatus comprising:
a first photosensitive member, a second photosensitive member, a third photosensitive member and a fourth photosensitive member that are arranged side by side at regular intervals along a moving direction of a transfer member onto which toner images formed on the first, the second, the third and the fourth photosensitive drums are transferred, the first photosensitive drum being disposed at a most upstream position with respect to the moving direction of the transfer member and the fourth photosensitive member being disposed at a most downstream position with respect to the moving direction of the transfer member;
light sources for emitting beams for exposure of the first, the second, the third and the fourth photosensitive drums; and
an optical system for directing the beams emitted from the light sources to the first, the second, the third and the fourth photosensitive drums;
wherein the optical system comprises a switching optical element that is capable of turning into a first state to direct one of the beams emitted from one of the light sources to the first photosensitive drum and into a second state to direct the beam from the light source to the fourth photosensitive drum; and
wherein a condition, A+B1−B2>F+E×D is satisfied, where A is a distance between a transfer point of the first photosensitive drum and a transfer point of the fourth photosensitive drum, B1 is a distance between an exposure point of the first photosensitive drum and the transfer point of the first photosensitive drum, B2 is a distance between an exposure point of the fourth photosensitive drum and the transfer point of the fourth photosensitive drum, D is a circumferential speed of rotation of the first and the fourth photosensitive drums, E is a time that is necessary for the switching optical element to turn from the first state to the second state or to turn from the second state to the first state; and F is a length of a copy sheet in a sub-scanning direction.

5. An image forming apparatus according to claim 4, further comprising a beam detector for generating synchronizing signals used to determine timings of starting image writing on the first and the second photosensitive drums;
wherein a beam splitting optical element for directing a part of the beam emitted from one of the light sources to the beam detector is disposed before the switching optical element.

6. An image forming apparatus comprising:
a first photosensitive drum, a second photosensitive drum, a third photosensitive drum and a fourth photosensitive drum that are arranged side by side in this order at regular intervals along a moving direction of a transfer member onto which toner images formed on the first, the second, the third and the fourth photosensitive drums are transferred, the first, the second, the third and the fourth photosensitive drums having equal diameters;
a first light source for emitting a beam;
a first switching optical element that is capable of turning into a first state to direct the beam emitted from the first light source to the first photosensitive drum and into a second state to direct the beam emitted from the first light source to the third photosensitive drum;
a second light source for emitting a beam; and
a second switching optical element that is capable of turning into a first state to direct the beam emitted from the second light source to the second photosensitive drum and into a second state to direct the beam emitted from the second light source to the fourth photosensitive drum;
wherein a condition, A>F+E×D is satisfied, where A is a distance between a transfer point of the first photosensitive drum and a transfer point of the third photosensitive drum, D is a circumferential speed of rotation of the first, the second, the third and the fourth photosensitive drums, E is a time that is necessary for each of the first and the second switching optical elements to turn from the first state to the second state or to turn from the second state to the first state; and F is a length of a copy sheet in a sub-scanning direction.

7. An image forming apparatus according to claim 6, further comprising a beam detector for generating synchronizing signals used to determine timings of starting image writing on the first, the second, the third and the fourth photosensitive drums;
wherein a beam splitting optical element for directing a part of the beam emitted from one of the first and the second light sources to the beam detector is disposed before the first switching optical element or the second switching optical element.
